(19) United States
(12) Patent Application Publication
(10) Pub. No.: US 2002/0188447 A1
(43) Pub. Date: Dec. 12, 2002

(54) Generation of grammars from dynamic data structures

(76) Inventors: Bradley S. Coon, Kokomo, IN (US); Andrew L. Wilhelm, Kokomo, IN (US)

Correspondence Address: JIMMY L. FUNKE, DELPHI TECHNOLOGIES, INC, Legal Staff Mail Code A-107, P.O. Box 9005, Kokomo, IN, 46904-9005, US

(21) Appl. No.: 09/834,087

(22) Filed: Apr. 10, 2001

(51) Int. Cl. G10L 15/00; G10L 17/00

(52) U.S. Cl. 704/249

(57) ABSTRACT

Voice access is provided to information stored in a dynamic database located within an external data source. A communication link is provided between the external data source and a voice capable device, which includes a speech recognition application and a grammar generation application. Text data is then retrieved from the dynamic database located within the external data source. The text data is then organized into new grammars, which are then converted into phonetic transcriptions. The new and existing grammars are then available to the speech recognition application to facilitate speech recognition.

### TECHNICAL FIELD

The present invention is generally directed to speech recognition and, more specifically, to the generation of grammars from dynamic data structures.

### BACKGROUND OF THE INVENTION

As is well known to one of ordinary skill in the art, speech recognition is a field in computer science that deals with designing computer systems that can recognize spoken words. A number of speech recognition systems are currently available (e.g., products are offered by IBM, Lernout & Hauspie and Philips). Traditionally, speech recognition systems have only been used in a few specialized situations due to their cost and limited functionality. For example, such systems have been implemented when a user was unable to use a keyboard to enter data because the user's hands were disabled. Instead of typing commands, the user spoke into a microphone. However, as the cost of these systems has continued to decrease and the performance of these systems has continued to increase, speech recognition systems are being used in a wider variety of applications (as an alternative to keyboards or other user interfaces). For example, speech actuated control systems have been implemented in motor vehicles to control various accessories within the motor vehicles.

A typical speech recognition system, that is implemented in a motor vehicle, includes voice processing circuitry and memory for storing data representing command words (that are employed to control various vehicle accessories). In a typical system, a microprocessor is utilized to compare the user provided data (i.e., voice input) to stored speech models to determine if a word match has occurred and provide a corresponding control output signal in such an event. The microprocessor has also normally controlled a plurality of motor vehicle accessories, e.g., a cellular telephone and a radio. Such systems have advantageously allowed a driver of the motor vehicle to maintain vigilance while driving the vehicle.

Most speech recognition systems have generally used fixed grammars that cannot be modified during use of the system. For example, a typical dial-up directory assistance service initially generates grammars, which are an integral part of the service, that are based on names in a phone directory. While the names in the phone directory may change over time, the data is an integral part of the application and, as such, is generally only updated periodically (e.g., once a year). Further, information stored in devices, such as handheld computers, has traditionally only been accessible via a hands-on visual interface. This has been, at least in part, because many of these devices have not included adequate computing resources to implement a voice interface. While data in such devices is typically dynamic (i.e., subject to change) and the organization or structure of the data is also generally dynamic, traditional embedded recognizers have normally only been designed for static data. That is, speaker independent words are predefined prior to manufacturing of a product and speaker dependent words have required training in order to adapt to changing data.

Thus, what is needed is a speech recognition system that can generate grammars from dynamic data structures located within an external data source and, as a result, automatically adapt to data and structure changes in a database located in the external data source.

### SUMMARY OF THE INVENTION

The present invention is directed to providing voice access to information stored in a dynamic database located within an external data source. A communication link is provided between the external data source and a voice capable device, which includes a speech recognition application and a grammar generation application. Text data is then retrieved from the dynamic database located within the external data source. The text data is then organized into new grammars, which are then converted into phonetic transcriptions. The new and existing grammars are then available to the speech recognition application to facilitate speech recognition.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a block diagram of an exemplary speech recognition system implemented within a motor vehicle;

FIG. 2 is a flow diagram of an exemplary routine for generating grammars from a database located in an external data source (e.g., a handheld computer system), according to an embodiment of the present invention;

FIG. 3 is a flow diagram of an exemplary routine for generating grammars that correspond to data received from a wireless data service, according to an embodiment of the present invention; and

FIG. 4 is an exemplary block diagram of a hierarchical data structure that can be converted into grammars to create a voice control structure that mirrors the hierarchical data structure.

### DESCRIPTION OF THE PREFERRED EMBODIMENT(S)

According to the present invention, voice access is provided to information stored in a dynamic database located within an external data source. A communication link is provided between the external data source and a voice capable device, which includes a speech recognition application and a grammar generation application. Text data is retrieved from the dynamic database that is located within the external data source. The text data is organized into grammars, which are converted into phonetic transcriptions contexts, when the phonetic transcriptions do not correspond to an existing grammar. The new and existing grammars are then available to the speech recognition application to facilitate speech recognition.

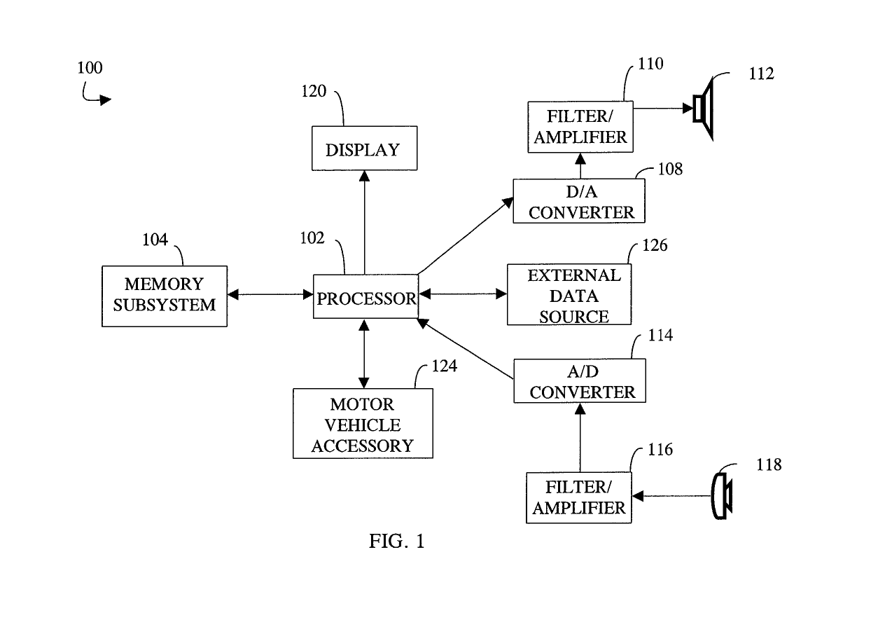

FIG. 1 depicts a block diagram of an exemplary speech recognition system 100, preferably, implemented within a motor vehicle (not shown), that provides dynamic grammar generation, according to an embodiment of the present invention. As shown, the speech recognition system 100 includes a processor 102 coupled to a motor vehicle accessory 124 (e.g., a cellular telephone) and a display 120. The processor 102 may control the motor vehicle accessory 124, at least in part, as dictated by voice input supplied by a user of the system 100. The processor 102 may also supply various information to a user, via the display 120 and/or the speaker 112, to allow the user of the motor vehicle to better utilize the system 100. In this context, the term processor may include a general purpose processor, a microcontroller (i.e., an execution unit with memory, etc., integrated within a single integrated circuit) or a digital signal processor (DSP). The processor 102 is also coupled to a memory subsystem 104, which includes an application appropriate amount of main memory (e.g., volatile and non-volatile memory).

An audio input device 118 (e.g., a microphone) is coupled to a filter/amplifier module 116. The filter/amplifier module 116 filters and amplifies the voice input provided by the user through the audio input device 118. The filter/amplifier module 116 is also coupled to an analog-to-digital (A/D) converter 114. The A/D converter 114 digitizes the voice input from the user and supplies the digitized voice to the processor 102 which, in turn, executes a speech recognition application that causes the voice input to be compared to system recognized commands.

The processor 102 executes various routines in determining whether the voice input corresponds to a system recognized command. The processor 102 may also cause an appropriate voice output to be provided to the user through an audio output device 112. The synthesized voice output is provided by the processor 102 to a digital-to-analog (D/A) converter 108. The D/A converter 108 is coupled to a filter/amplifier section 110, which amplifies and filters the analog voice output. The amplified and filtered voice output is then provided to audio output device 112 (e.g., a speaker). While only one motor vehicle accessory module 124 is shown, it is contemplated that any number of accessories (e.g., a cellular telephone, a radio, etc.), typically provided in a motor vehicle, can be implemented.

According to the present invention, the processor 102 also executes a grammar generation application that creates new grammars or modifies existing grammars when text data stored in a dynamic database, located within an external data source 126, does not correspond to an existing grammar.

The external data source 126 can be of a wide variety of devices, including a wireless data device, a compressed music player (e.g., motion picture expert group audio layer 3 (MP3) and windows media audio (WMA)) and a data capable radio. The wireless data device can be a handheld computer, such as a personal digital assistant (PDA), with a wireless data subscription, or a web phone, to name a few devices. Using the present invention, information on various devices can be accessed with one or more voice commands. For example, with data capable radios (e.g., radio data systems (RDS), satellite digital audio receiver service (SDARS), and digital audio broadcast (DAB)), voice access can be provided to an assortment of available audio channels. When the external data source 126 is a compressed music player, a voice command can initiate the play of a particular song stored in a memory of the compressed music player. According to the present invention, when a user desires voice access to an address book stored on, for example, a PDA, which may not have sufficient computing resources for a stand-alone voice interface, the address of an individual may be provided (visually or audibly) in response to a voice command. This is advantageous in that access can be readily provided to an address book, stored in a PDA, that may contain hundreds of names and corresponding addresses.

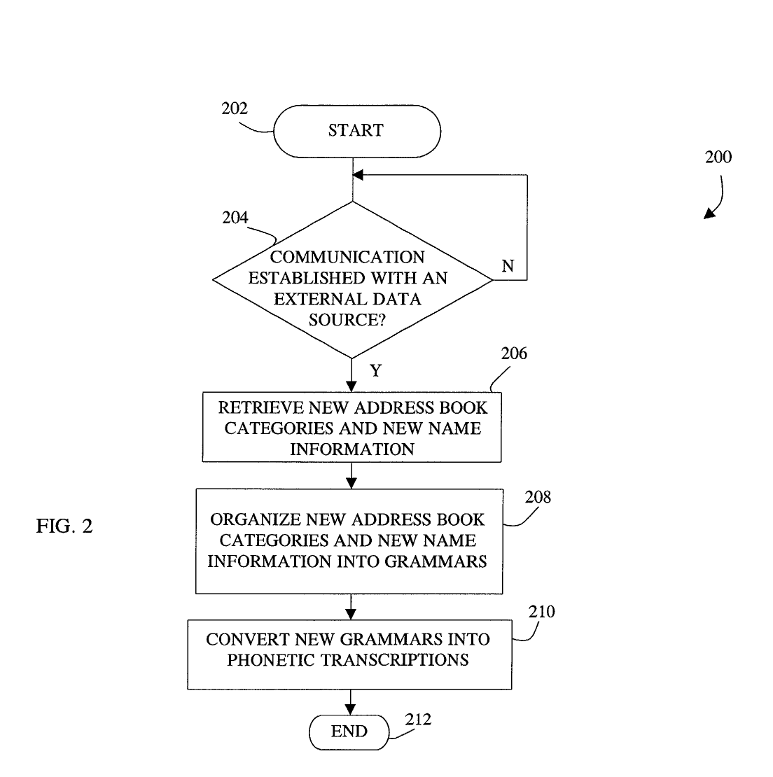

A handheld routine 200 for generating grammars from a handheld computer system is illustrated in FIG. 2. When a user wishes to retrieve information from the external data source 126, the user establishes a communication link (e.g., docks the source 126 with the system 100) between the external data source (e.g., a PDA) 126 and the speech recognition system 100, which contains a speech recognition application. In step 202, the routine 200 is initiated. Next, in decision step 204, the routine 200 determines whether communication between the external data source 126 and the speech recognition system 100 is established. If communication is not established, control loops on step 204, while the routine 200 is active, until communication is established. Next, in step 206, the processor 102 retrieves appropriate address book category and name information from the PDA. The processor 102, executing a grammar generation application, then organizes the new address book categories and new name information into grammars in step 208. Next, in step 210, the processor 102 converts the new grammars into phonetic transcriptions that are useable by the speech recognition application. The address book category names and individual names within those categories are then available to be recognized by voice, without user intervention.

When a user wishes to add a new category of names or a new name to an existing category, the user typically removes the PDA from the speech recognition system 100 and creates the new address book category with the appropriate address book entries for the members of the category. Upon reestablishing communication with the system 100, the system 100 automatically retrieves the added address book category and name information from the PDA. The grammar generation application, stored within the system 100, then organizes the new address book categories and new name information into grammars and converts the new grammars into phonetic transcriptions that are useable by the speech recognition application. According to the present invention, the user can then navigate to the newly created category in the address book with an appropriate voice input. Upon navigating to the new category, the names in the new category are available for recognition, via voice input. According to the present invention, the new data structure is accommodated without user training or recompiling of the speech recognition application.

Accordingly, a speech recognition system has been described that provides automatic grammar generation based on data retrieved from an external data source. The automatic updating of grammars is based on changes to the data (i.e., content and structure) stored within the external data source. Advantageously, no user training or other user intervention is required to create the new grammars. The new grammars may also be used for the control of an external data source or other devices (e.g., a motor vehicle accessory) based on the dynamically generated grammars.

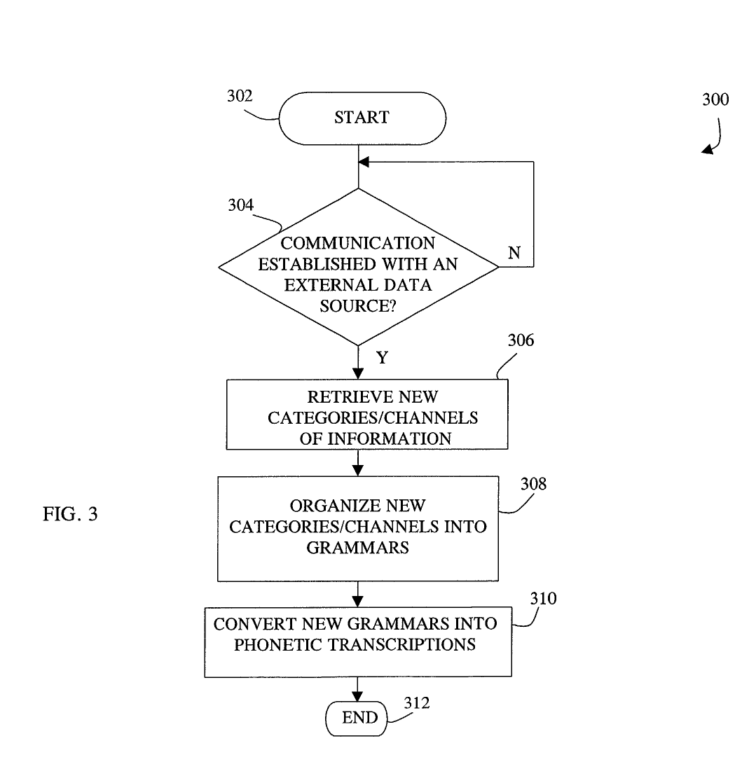

FIG. 3 illustrates a data capable radio routine 300, according to another embodiment of the present invention. In step 302, the routine 300 is initiated. From step 302, control transfers to decision step 304 where the processor 102, executing routine 300, determines whether communication is established between the speech recognition system 100 and the external data source 126. As previously mentioned, the external data source 126 may be a data capable radio such as a radio data system (RDS) receiver, a digital audio broadcast (DAB) receiver or a satellite digital audio receiver service (SDARS) receiver. When communication is established in step 304, control transfers to step 306. In step 306, the processor 102 retrieves new categories or channels of information. Next, in step 308, the processor 102 organizes the new category or channels into grammars. Then, in step 310, the processor 102 converts the new grammars into phonetic transcriptions that can be utilized by the speech recognition application. In step 312, routine 300 terminates.

Thus, when the external data source is a subscription entertainment service such as a satellite digital audio receiver service (SDARS), the grammar generation algorithm is utilized to retrieve available channel information from the receiver and generate grammars for currently existing channels. When a wireless service provider adds a new channel to the service, the next time the grammar generation algorithm accesses data from the receiver, the new set of categories/channels that are detected are organized into grammars and converted to phonetic transcriptions for use by the recognizer. The user can then select any of the categories/channels by speaking the category/channel name.

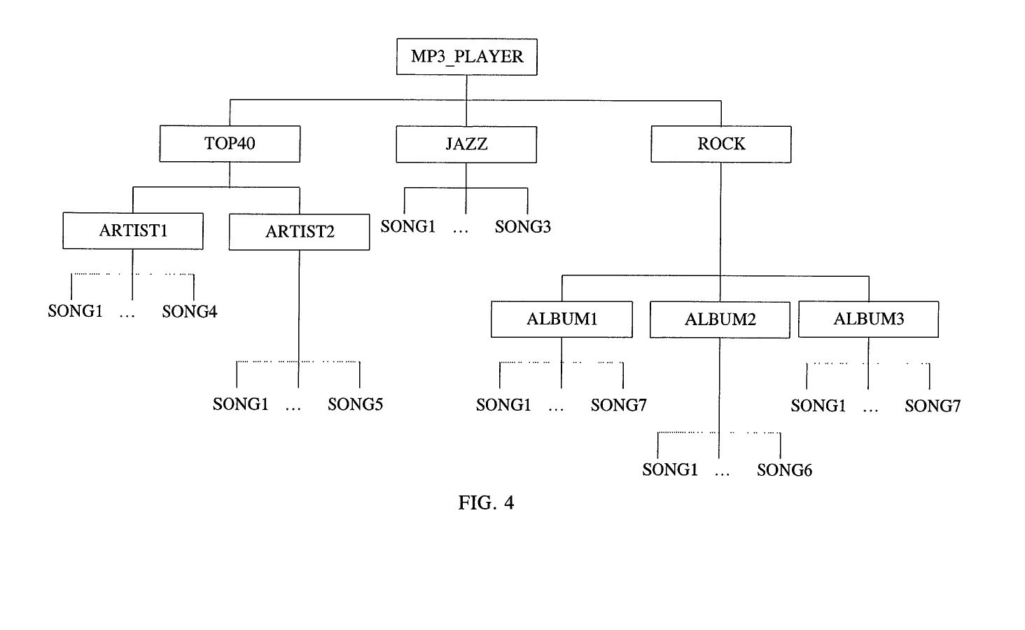

FIG. 4 depicts an exemplary block diagram of a hierarchical data structure that can be converted into grammars to create a voice control structure that mirrors the hierarchical data structure. In FIG. 4, ‘ARTIST1’ and ‘ARTIST2’ correspond to the name of an artist, ‘SONG1’ through ‘SONG7’ correspond to the title of a particular song and ‘ALBUM1’, ‘ALBUM2’ and ‘ALBUM3’ correspond to the title of a particular album. A number of grammars that correspond to FIG. 4 are set forth below:

Exemplary Resultant Grammars Corresponding To FIG. 4:

<MP3_PLAYER>: TOP40|JAZZ ROCK|ALL SONGS|TOP40<TOP40>|ROCK <ROCK >;

<TOP40>: ARTIST1|ARTIST2;

<JAZZ>: SONG1|SONG2|SONG3;

<ROCK>: ALBUM1|ALBUM2|ALBUM3

<TOP40_ARTISTI >: SONG1|SONG2|SONG3|SONG4;

<TOP40 ARTIST2>: SONG1|SONG2|SONG3|SONG4|SONG5;

<ROCK_ALBUM1>: SONG1|SONG2|SONG3|SONG4|SONG5|SONG6|SONG7;

<ROCK_ALBUM2): SONG1|SONG2|SONG3|SONG4|SONG5|SONG6;

<ROCK_ALBUM3): SONG1|SONG2|SONG3|SONG4|SONG5|SONG6|SONG7;

<ALL_SONGS>: <JAZZ>|<TOP40_ARTIST1>|<TOP40_ARTIST2>|<ROCK_ALBUM1>|<ROCK_ALBUM2>|<ROCK_ALBUM3>;

As used above, a term in brackets ‘< >’ is a grammar or sub-grammar, etc. and a bar ‘|’ between two terms indicates the terms are alternatives. For example, in the string ‘<MP3_PLAYER >: JAZZ |TOP40<TOP40>; <TOP40>: ARTIST1|ARTIST2;’ MP3_PLAYER is a grammar, JAZZ and TOP40 are recognizable words and <TOP40> is a sub-grammar. Thus, a user may say ‘JAZZ’ or ‘TOP40 ARTIST1’ or ‘TOP40 ARTIST2’ followed by a title of a song to initiate the play of the desired song.

A number of exemplary voice interactions between a computer and a user are set forth below:

### EXAMPLE 1

| | | |
|---|---|---|
| 1. | User: | Presses Button |
| 2. | Computer: | “READY” |
| 3. | User: | “MP3 PLAYER” |
| 4. | Computer: | “WHAT CATEGORY?” |
| 5. | User: | “TOP40” |
| 6. | Computer: | “WHAT TOP40 CATEGORY?” |
| 7. | User: | “ARTIST1” |
| 8. | Computer: | “WHAT ARTIST1 SONG?” |
| 9. | User: | “SONG3” |

### EXAMPLE 2

| | | |
|---|---|---|
| 1. | User: | Presses Button |
| 2. | Computer: | “READY” |
| 3. | User: | “MP3 PLAYER” |
| 4. | Computer: | “WHAT MP3 CATEGORY?” |
| 5. | User: | “ALL SONGS?” |
| 6. | Computer: | “WHAT SONG?” |
| 7. | User: | “ROCK ALBUM2 SONG5” |

### EXAMPLE 3

| | | |
|---|---|---|
| 1. | User: | Presses Button |
| 2. | Computer: | “READY” |
| 3. | User: | “MP3 PLAYER” |
| 4. | Computer: | “WHAT MP3 CATEGORY?” |
| 5. | User: | “TOP40 ARTIST2” |
| 6. | Computer: | “WHAT ARTIST2 SONG?” |
| 7. | User: | “SONG2” |

Accordingly, as described above, voice access is provided to information stored in a dynamic database located within an external data source. As previously discussed, a communication link is provided between the external data source and a voice capable device, which includes a speech recognition application and a grammar generation application. Text data is retrieved from the dynamic database that is located within the external data source. The text data is then organized into grammars, which are converted into phonetic transcriptions, when the phonetic transcriptions do not correspond to an existing grammar. The new and existing grammars are then available to the speech recognition application to facilitate speech recognition.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the Doctrine of Equivalents.

1. A method for providing voice access to information stored in a dynamic database located within an external data source, comprising the steps of:
providing a communication link between an external data source and a voice capable device, the voice capable device including a speech recognition application and a grammar generation application;
retrieving text data from a dynamic database located within the external data source;
organizing the text data into new grammars; and
converting the new grammars into phonetic transcriptions,
wherein the new and existing grammars are then available to the speech recognition application to facilitate speech recognition.

2. The method of claim 1, wherein the external data source is one of a handheld computer, a compressed music player, a digital cellular telephone, a radio data system (RDS) receiver and a digital audio broadcast (DAB) receiver.

3. The method of claim 1, further including the steps of:
receiving a voice command that is directed to the external data source;
utilizing the new and existing grammars that are necessary to interpret the received voice command; and
controlling the external data source to perform a function associated with the received voice command.

4. The method of claim 1, further including the steps of:
receiving a voice command that is directed to the external data source;
utilizing the new and existing grammars that are necessary to interpret the received voice command; and
retrieving information from the external data source that is associated with the received voice command.

5. The method of claim 1, wherein the external data source includes a voice interface.

6. The method of claim 1, further including the step of:
modifying at least one of the existing grammars with the phonetic transcriptions.

7. The method of claim 1, wherein the new grammar corresponds to at least one of a new word in the database and a change in the structure of the database.

8. A speech recognition system for providing voice access to information stored in a dynamic database located within an external data source, the system comprising:
a processor;
a memory subsystem coupled to the processor; and
processor executable code for implementing a speech recognition application and a grammar generation application and for causing the processor to perform the steps of:
providing a communication link between an external data source and the speech recognition system;
retrieving text data from a dynamic database located within the external data source;
organizing the text data into new grammars; and
converting the new grammars into phonetic transcriptions, wherein the new and existing grammars are then available to the speech recognition application to facilitate speech recognition.

9. The system of claim 8, wherein the external data source is one of a handheld computer, a compressed music player, a digital cellular telephone, a radio data system (RDS) receiver and a digital audio broadcast (DAB) receiver.

10. The system of claim 8, wherein the processor executable code causes the processor to perform the additional steps of:
receiving a voice command that is directed to the external data source;
utilizing the new and existing grammars that are necessary to interpret the received voice command; and
controlling the external data source to perform a function associated with the received voice command.

11. The system of claim 8, wherein the processor executable code causes the processor to perform the additional steps of:
receiving a voice command that is directed to the external data source;
utilizing the new and existing grammars that are necessary to interpret the received voice command; and
retrieving information from the external data source that is associated with the received voice command.

12. The system of claim 8, wherein the external data source includes a voice interface.

13. The system of claim 8, further including the step of:
modifying at least one of the existing grammars with the phonetic transcriptions.

14. The system of claim 8, wherein the new grammar corresponds to at least one of a new word in the database and a change in the structure of the database.

15. A speech recognition system located within a motor vehicle and providing voice access to information stored in a dynamic database located within an external data source, the system comprising:
a processor;
an output device coupled to the processor, the output device providing information to an occupant of the motor vehicle;
a memory subsystem for storing information coupled to the processor; and
processor executable code for implementing a speech recognition application and a grammar generation application and for causing the processor to perform the steps of:
providing a communication link between an external data source and the speech recognition system;
retrieving text data from a dynamic database located within the external data source;
organizing the text data into new grammars; and
converting the new grammars into phonetic transcriptions, wherein the new and existing grammars are then available to the speech recognition application to facilitate speech recognition.

16. The system of claim 15, wherein the external data source is one of a handheld computer, a compressed music player, a digital cellular telephone, a radio data system (RDS) receiver and a digital audio broadcast (DAB) receiver.

17. The system of claim 15, wherein the processor executable code causes the processor to perform the additional steps of:
receiving a voice command that is directed to at least one of the external data source and a motor vehicle accessory;
utilizing the new and existing grammars that are necessary to interpret the received voice command; and
controlling at least one of the external data source and the motor vehicle accessory to perform a function associated with the received voice command.

18. The system of claim 15, wherein the processor executable code causes the processor to perform the additional steps of:
receiving a voice command that is directed to the external data source;
utilizing the new and existing grammars that are necessary to interpret the received voice command; and
retrieving information from the external data source that is associated with the received voice command.

19. The system of claim 15, wherein the external data source includes a voice interface.

20. The system of claim 15, further including the step of:
modifying at least one of the existing grammars with the phonetic transcriptions.

21. The system of claim 15, wherein the new grammar corresponds to at least one of a new word in the database and a change in the structure of the database.
